(19) United States
(12) Patent Application Publication
(10) Pub. No.: US 2026/0063766 A1
(43) Pub. Date: Mar. 5, 2026

(54) INFRARED SENSOR COVER

(71) Applicant: TOYOTA GOSEI CO., LTD., Kiyosu-shi (JP)

(72) Inventors: Yosuke TSUCHIYA, Kiyosu-shi (JP); Koji FUKAGAWA, Kiyosu-shi (JP); Hiroaki ANDO, Kiyosu-shi (JP); Takeshi YAGAMI, Kiyosu-shi (JP)

(21) Appl. No.: 19/281,001

(22) Filed: Jul. 25, 2025

(30) Foreign Application Priority Data
Aug. 30, 2024 (JP) 2024-148356
Nov. 22, 2024 (JP) 2024-204054

(51) Int. Cl. G01S 7/481

(52) U.S. Cl. CPC G01S 7/4811

(57) ABSTRACT

An infrared sensor cover is configured to cover an emitter and a receiver of an infrared sensor from the front with respect to an emission direction of infrared rays. The infrared sensor cover includes a cover body that allows passage of infrared rays. The cover body includes an anti-reflection layer that restricts reflection of emitted infrared rays. The anti-reflection layer serves as at least one of two opposite surfaces of the cover body in the emission direction. The anti-reflection layer has a uniform thickness. The anti-reflection layer is configured so that transmittance of the infrared rays through the cover body is maximal when the infrared rays are emitted onto the anti-reflection layer at an incident angle within an angular range of 30 degrees to 60 degrees, inclusive.

### CROSS-REFERENCE TO RELATED APPLICATIONS

This application is based upon and claims the benefit of priority from Japanese Patent Application No. 2024-148356, filed on Aug. 30, 2024, and Japanese Patent Application No. 2024-204054, filed on Nov. 22, 2024, the entire contents of each of which are incorporated herein by reference.

### BACKGROUND

### 1. Field

The following description relates to an infrared sensor cover configured to cover an emitter and a receiver of an infrared sensor from the front with respect to an emission direction of infrared rays.

### 2. Description of Related Art

An infrared sensor mounted on a vehicle includes an emitter and a receiver. The emitter emits infrared rays toward the outside of the vehicle while changing the emission direction within a predetermined angular range with respect to both a vehicle-widthwise direction and a vertical direction. The receiver receives infrared rays reflected by an object outside the vehicle, such as a front vehicle, a pedestrian, or the like. The emitted and received infrared rays are used to detect the position of the object, the distance from the vehicle to the object, the relative speed of the vehicle and the object, and the like.

If the infrared sensor is mounted on the vehicle in a state exposed to the outside, the emitter and the receiver may be seen from the front with respect to the emission direction of infrared rays. This may adversely affect the appearance of the infrared sensor and part of the vehicle around the infrared sensor. In addition, the emitter and the receiver should be protected from impacts or the like. Accordingly, the emitter and the receiver are covered by an infrared sensor cover from the front with respect to the emission direction of infrared rays. The infrared sensor cover includes a cover body that allows passage of infrared rays. In a typical example of such a cover body, at least one of two opposite surfaces of the cover body in the emission direction includes an anti-reflection layer that restricts reflection of the infrared rays.

In recently developed infrared sensors, the emitter is configured to emit infrared rays in a wider angular range (e.g., −60 degrees to +60 degrees inclusive) with respect to the vehicle-widthwise direction. In such a case, the infrared sensor cover is typically designed so that transmittance of the infrared rays through the cover body is maximal when the infrared rays are emitted onto the cover body at an incident angle of 0 degrees. However, as the incident angle increases, the reflectance increases and the transmittance decreases.

The above phenomenon may also occur when infrared rays are emitted onto a cover body that is significantly tilted relative to a vertical plane and a horizontal plane.

To avoid such situations, various types of infrared sensor covers have been suggested to reduce the decrease in the transmittance due to an increase in the incident angle. Japanese Laid-Open Patent Publication No. 2023-173264 describes a typical example of an infrared sensor cover that includes an anti-reflection layer configured so that the thickness of the anti-reflection layer where the incident angle is 45 degrees or greater and 60 degrees or less is “k” times greater than the thickness of the anti-reflection layer where the incident angle is 0 degrees. In this infrared sensor cover, the thickness of the anti-reflection layer is gradually increased as the incident angle increases.

However, it is technically difficult to form an anti-reflection layer having a thickness that gradually increases in accordance with the incident angle, such as that included in the above infrared sensor cover.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An infrared sensor cover in accordance with an aspect of the present disclosure is configured to be applied to an infrared sensor. The infrared sensor includes an emitter configured to emit infrared rays toward outside of a vehicle, and a receiver configured to receive the infrared rays reflected by an object outside the vehicle. The infrared sensor cover is configured to cover the emitter and the receiver from a front with respect to an emission direction of the infrared rays. The infrared sensor cover includes a cover body configured to allow passage of the infrared rays. The cover body includes an anti-reflection layer configured to restrict reflection of the emitted infrared rays. The anti-reflection layer serves as at least one of two opposite surfaces of the cover body in the emission direction. The anti-reflection layer has a uniform thickness. The anti-reflection layer is configured so that transmittance of the infrared rays through the cover body is maximal when the infrared rays are emitted onto the anti-reflection layer at an incident angle within an angular range of 30 degrees to 60 degrees, inclusive.

Other features and aspects will be apparent from the following detailed description, the drawings, and the claims.

### BRIEF DESCRIPTION OF THE DRAWINGS

FIG. 1 is a cross-sectional side view of an upper part (roof) of a vehicle at which an infrared sensor and an infrared sensor cover are arranged in accordance with an embodiment.

FIG. 2 is a schematic cross-sectional side view of the infrared sensor in accordance with the embodiment.

FIG. 3 is a plan view of the vehicle in accordance with the embodiment, illustrating an angular range within which an emission direction of infrared rays is changed with respect to a sideward direction of the vehicle.

FIG. 4 is a schematic diagram illustrating the infrared sensor and an enlarged cross-sectional structure of part of a cover body in accordance with the embodiment.

FIG. 5 is a graph showing measurement results of transmittance of infrared rays at each incident angle.

FIG. 6 is a cross-sectional plan view of a modified example of the infrared sensor cover separate from the infrared sensor.

FIG. 7 is a cross-sectional plan view of another modified example of the infrared sensor cover separate from the infrared sensor.

FIG. 8 is a schematic cross-sectional side view of an infrared sensor including a modified example of the infrared sensor cover.

FIG. 9 is a partial cross-sectional side view of a modified example of the infrared sensor cover including part of a glass of the vehicle.

FIG. 10 is a partial cross-sectional side view of a modified example of the infrared sensor cover including part of a glass of the vehicle.

FIG. 11 is a partial cross-sectional side view of a modified example of the infrared sensor cover incorporated in a glass of the vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

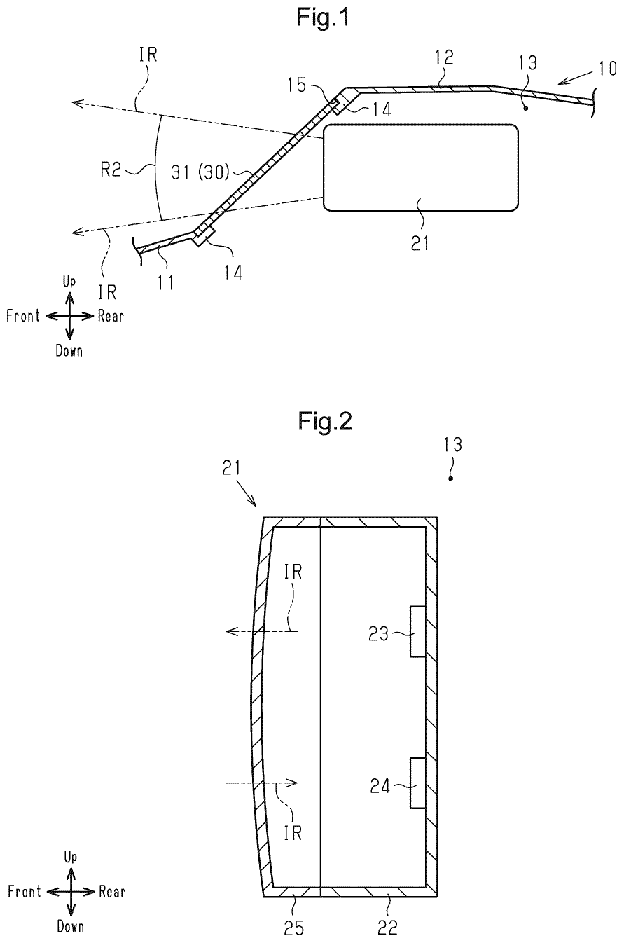

An infrared sensor cover for a land vehicle in accordance with an embodiment of the present disclosure will now be described with reference to FIGS. 1 to 5.

In the description hereafter, the term “the front” corresponds to the front of the vehicle 10 toward which the vehicle 10 travels in a forward-moving direction, and the term “the rear” corresponds to the rear of the vehicle 10 toward which the vehicle 10 travels in a rearward-moving direction. The term “vertical direction” means the vertical direction of the vehicle 10. The term “sideward direction” corresponds to the vehicle-widthwise direction, which coincides with the sideward direction of the vehicle 10 when the vehicle 10 is traveling forward.

### Upper Structure of Vehicle 10

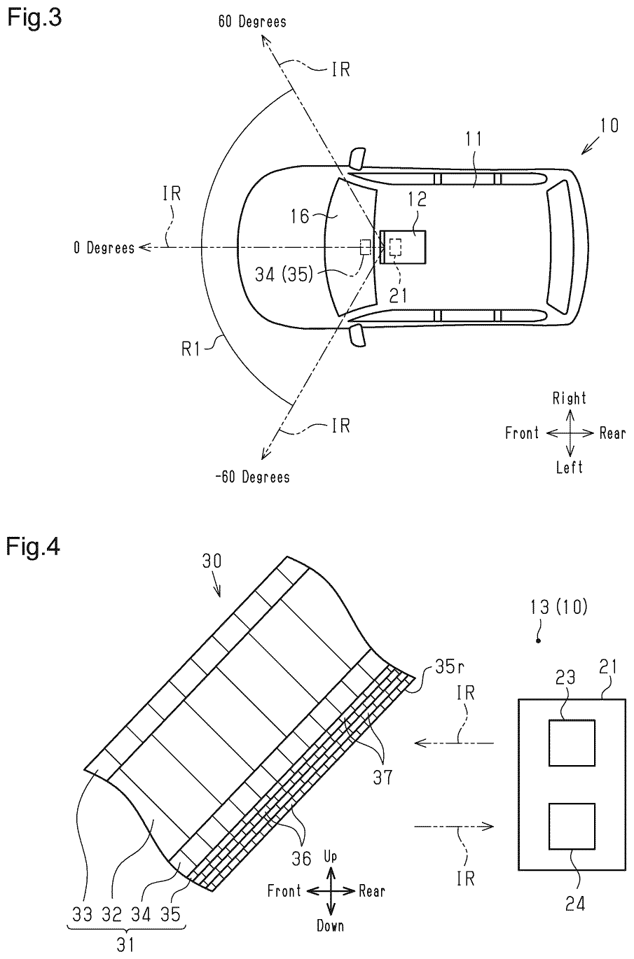

As shown in FIGS. 1 and 3, the land vehicle 10, which is an example of a vehicle, includes a plate-shaped roof member 11 at an upper part of the vehicle 10. The roof member 11 forms at least a part of a roof extending over a passenger compartment of the vehicle 10. The roof member 11 is configured to protect the occupants from rain, wind, snow, sunlight, or the like.

The roof member 11 includes a protrusion 12 at an upper part of the roof member 11. The protrusion 12 protrudes upward from a portion (in the present embodiment, central portion) of the roof member 11 in the sideward direction. The protrusion 12 has an internal cavity 13. The protrusion 12 includes a sloped part 14 at a front end of the protrusion 12. The sloped part 14 is significantly tilted relative to both a vertical plane and a horizontal plane, such that the sloped part 14 becomes closer to the front as the sloped part 14 extends downwardly. The sloped part 14 includes a window 15 that connects the cavity 13 in the protrusion 12 and an area external to the protrusion 12, specifically, an area at the front.

An infrared sensor 21 and an infrared sensor cover 30 are arranged at the upper part (roof) of the vehicle 10 where the protrusion 12 is formed. Each of the components will now be described.

### Infrared Sensor 21

The infrared sensor 21 is for monitoring the front and the front sides of the vehicle 10. In the present embodiment, the infrared sensor 21 includes a light detection and ranging (LiDAR) device. At least part of the infrared sensor 21 (in the present embodiment, the entire infrared sensor 21) is located inside the protrusion 12 and rearward from the window 15. In other words, the entire infrared sensor 21 is located upward from the roof member 11.

As shown in FIG. 2, the infrared sensor 21 includes a case 22 and a cover 25. The case 22 has an open front end and serves as a rear half of the shell of the infrared sensor 21. The cover 25 serves as a front half of the shell of the infrared sensor 21. The case 22 accommodates an emitter 23 and a receiver 24 of infrared rays IR.

The emitter 23 is configured to emit infrared rays IR having a wavelength of approximately 900 nm toward the outside of the vehicle 10. As shown in FIG. 3, the emitter 23 emits infrared rays IR while changing an emission direction within a predetermined angular range R1 with respect to the sideward direction. Further, as shown in FIG. 1, the emitter 23 emits infrared rays IR while changing the emission direction within a predetermined angular range R2 with respect to the vertical direction.

As shown in FIG. 2, the receiver 24 receives infrared rays IR reflected by an object (not shown) outside the vehicle, such as a front vehicle, a pedestrian, or the like. The infrared sensor 21 recognizes the object based on the emitted infrared rays IR and the received infrared rays IR, and detects the distance from the vehicle 10 to the object, the relative speed of the vehicle 10 and the object, or the like.

As described above, the infrared sensor 21 emits infrared rays IR toward the front of the vehicle 10. Therefore, the emission direction of the infrared rays IR from the infrared sensor 21 corresponds to a direction extending from the rear of the vehicle 10 toward the front. The front with respect to the emission direction of the infrared rays IR substantially coincides with the front of the vehicle 10. The rear with respect to the emission direction substantially coincides with the rear of the vehicle 10. Thus, in the description hereafter, the front with respect to the emission direction of the infrared rays IR may simply be referred to as “forward” or “the front”, and the rear with respect to the emission direction may simply be referred to as “rearward” or “the rear”.

The cover 25 is disposed frontward from the case 22, so that the cover 25 covers the emitter 23 and the receiver 24 from the front.

### Infrared Sensor Cover 30

As shown in FIGS. 1 and 4, the infrared sensor cover 30 of the present embodiment is arranged separately from the infrared sensor 21. The infrared sensor cover 30 is attached to the sloped part 14 and closes the window 15. Accordingly, the infrared sensor cover 30 is disposed frontward from the infrared sensor 21 and is significantly tilted relative to both the vertical plane and the horizontal plane, such that the infrared sensor cover 30 becomes closer to the front as the infrared sensor cover 30 extends downwardly.

The infrared sensor cover 30 includes a cover body 31 that allows passage of infrared rays IR. The cover body 31 serves as a framework of the infrared sensor cover 30. The cover body 31 is disposed frontward from the infrared sensor 21 so that the cover body 31 indirectly covers the emitter 23 and the receiver 24 from the front. In this case, the cover 25 of the infrared sensor 21 (refer to FIG. 2) is located between the cover body 31 and the case 22, which accommodates the emitter 23 and the receiver 24.

The infrared sensor cover 30 includes an attachment portion (not shown) in addition to the cover body 31. The infrared sensor cover 30 is attached to the sloped part 14 or the like of the protrusion 12 by screw fastening, claw fitting, or the like, at the attachment portion.

The infrared sensor cover 30 covers the emitter 23 and the receiver 24 from the front for purposes of decorating the upper part of the vehicle 10 and also protecting the emitter 23 and the receiver 24 from impacts or the like.

As shown in FIG. 4, the cover body 31 includes a base 32, a hard coat layer 33, a protection layer 34, and an anti-reflection layer 35, each allowing passage of infrared rays IR. The cover body 31 is plate-shaped and has a uniform thickness. Each of the components will now be described.

The base 32 is plate-shaped and serves as a framework of the cover body 31. The base 32 is formed from a polycarbonate (PC) resin. Alternatively, the base 32 may be formed from an acrylic resin, such as a polymethyl methacrylate (PMMA) resin. In the present embodiment, the base 32 is formed from a resin material containing PC as a main component. The resin material is colored in black or the like by mixing a coloring material, such as a colorant, with the PC.

The hard coat layer 33 is formed by, for example, applying an acrylic paint to a front surface of the base 32. The hard coat layer 33 has a higher hardness than the base 32. The front surface of the hard coat layer 33 serves as a front surface of the cover body 31, and also serves as an ornamental surface of the infrared sensor cover 30. The hard coat layer 33 may be formed by a hard coat film having a higher hardness than the base 32.

The anti-reflection layer 35 serves as at least one of two opposite surfaces of the cover body 31 in the emission direction. In the present embodiment, the anti-reflection layer 35 is arranged at a rearmost part of the cover body 31, so that a rear surface 35r of the anti-reflection layer 35 serves as a rear surface of the cover body 31. The anti-reflection layer 35 has a uniform thickness. The anti-reflection layer 35 reduces reflection of infrared rays IR emitted from the emitter 23 by having the infrared rays IR interfere each other, so that a decrease in the amount of the infrared rays IR that pass through the cover body 31 due to the reflection is limited.

In the present embodiment, the anti-reflection layer 35 is formed by a dielectric multilayer film. The anti-reflection layer 35 may be formed by a different type of film. The dielectric multilayer film refers to a film formed by alternately stacking a dielectric thin film 36 and a dielectric thin film 37 by vacuum deposition, sputtering, wet coating, or the like. The dielectric thin film 36 is formed from a material having a relatively high refractive index. The dielectric thin film 37 is formed from a material having a lower refractive index than the dielectric thin film 36. In the present embodiment, the anti-reflection layer 35 is formed by alternately stacking the dielectric thin film 36 formed from silica, and the dielectric thin film 37 formed from niobia. Such a structure is merely an example, and the dielectric thin films 36 and 37 may be formed from other types of materials. The dielectric thin films 36 and 37 each have a uniform thickness.

When the anti-reflection layer 35 includes the dielectric thin films 36 are 37 as described above, there is a correlation between an incident angle at which transmittance of infrared rays IR through the cover body 31 is maximal and the thicknesses of the dielectric thin films 36 and 37.

Specifically, when infrared rays IR are emitted onto the dielectric thin film 36, 37 of the anti-reflection layer 35, some of the infrared rays IR pass through one of two opposite surfaces, specifically, the surface irradiated with the infrared rays IR, of the dielectric thin film 36, 37 in the thickness-wise direction. The remainder of the infrared rays IR are reflected by the same surface. The infrared rays IR that passed through the irradiated surface reach the other surface; specifically, the surface not irradiated with the infrared rays IR, of the dielectric thin film 36, 37. Some of the infrared rays IR that reached the other surface pass through the surface, and the remainder of the infrared rays IR are reflected by the same surface. The level of transmission or reflection of the infrared rays IR at each surface may be quantitatively expressed by the Fresnel equation. When the thickness of the dielectric thin film 36, 37 is an odd multiple of a ¼ wavelength of the infrared rays IR, the reflection waves generated at the two opposite surfaces interfere with each other and cancel each other out. This restricts reflection of the infrared rays IR by the anti-reflection layer 35. The thickness of the dielectric thin film 36, 37 depends on both the refractive index of the dielectric thin film 36, 37 and the incident angle of the infrared rays IR.

Taking into consideration the above, in the present embodiment, the thicknesses of the dielectric thin films 36 and 37 are each set to satisfy the following conditions in a relationship between the incident angle of infrared rays IR and the transmittance of infrared rays IR through the cover body 31.

Condition 1: The thicknesses of the dielectric thin films 36 and 37 are each set to a value that maximizes transmittance of infrared rays IR when infrared rays IR are emitted onto the anti-reflection layer 35 at an incident angle within an angular range of 30 degrees and 60 degrees, inclusive.

Condition 2: The thicknesses of the dielectric thin films 36 and 37 are each set to a value at which transmittance of infrared rays IR is 90% or higher when infrared rays IR are emitted onto the anti-reflection layer 35 at an incident angle within an angular range of 0 degrees to 60 degrees, inclusive.

The protection layer 34 is formed between the base 32 and the anti-reflection layer 35. The protection layer 34 enhances the adhesion between the anti-reflection layer 35 and the base 32. In the present embodiment, the protection layer 34 is formed by applying an UV-curable acrylic resin to a rear surface of the base 32.

### Operation of the Present Embodiment

As shown in FIGS. 1 to 3, when the emitter 23 of the infrared sensor 21 emits infrared rays IR, the infrared rays IR are emitted from the rear onto the cover body 31 of the infrared sensor cover 30, and pass through the cover body 31 toward the front. The infrared rays IR that passed through the cover body 31 are reflected by an object outside the vehicle 10 back to the cover body 31 from the front, and pass through the cover body 31 toward the rear. The receiver 24 receives such infrared rays IR that passed through the cover body 31.

As shown in FIG. 4, in the present embodiment, the anti-reflection layer 35 is arranged at the rearmost part of the cover body 31. This part of the cover body 31 is where the cover body 31 is irradiated with infrared rays IR emitted from the emitter 23 of the infrared sensor 21. Therefore, the amount of infrared rays IR emitted from the emitter 23 and reflected by the anti-reflection layer 35 is decreased, and the amount of infrared rays IR that pass through the cover body 31 toward the front is increased. As a result, a greater amount of infrared rays IR passes through the cover body 31 toward the front, as compared to when the anti-reflection layer 35 is not included.

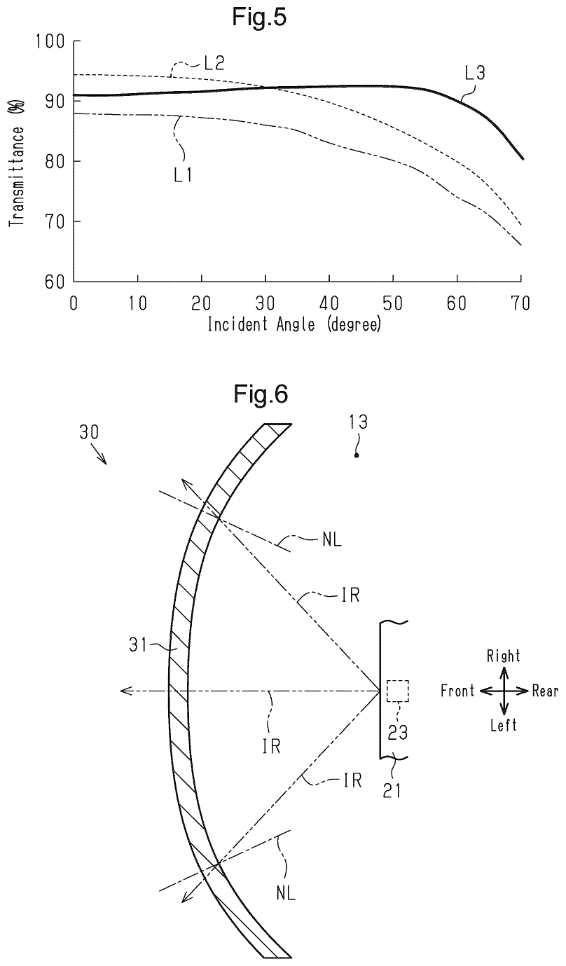

FIG. 5 shows measurement results of a relationship between the incident angle of infrared rays IR and the transmittance of infrared rays IR through the cover body. In FIG. 5, characteristic line L1 indicates measurement results of measurement subject 1. Characteristic line L2 indicates measurement results of measurement subject 2. Characteristic line L3 indicates measurement results of measurement subject 3.

Measurement subject 1 is an infrared sensor cover in which the cover body includes only the base 32. In this case, infrared rays IR are emitted onto the rear surface of the base 32 of measurement subject 2.

Measurement subject 2 is an infrared sensor cover in which the cover body includes the base 32, the hard coat layer 33, the protection layer 34, and the anti-reflection layer 35. The thicknesses of the dielectric thin films 36 and 37 in the anti-reflection layer 35 are each set to be uniform. Further, the thicknesses of the dielectric thin films 36 and 37 are each set to a value that maximizes transmittance of infrared rays IR through the cover body when infrared rays IR are emitted onto the anti-reflection layer 35 at an incident angle of 0 degrees.

Measurement subject 3 is the infrared sensor cover 30 of the above embodiment. Specifically, as shown in FIG. 4, measurement subject 3 is the infrared sensor cover 30 in which the cover body 31 includes the base 32, the hard coat layer 33, the protection layer 34, and the anti-reflection layer 35. The thicknesses of the dielectric thin films 36 and 37 in the anti-reflection layer 35 are each set to be uniform. Further, the thicknesses of the dielectric thin films 36 and 37 are each set to a value that maximizes transmittance of infrared rays IR through the cover body 31 when infrared rays IR are emitted onto the anti-reflection layer 35 at an incident angle within an angular range of 30 degrees to 60 degrees, inclusive.

In measurement subject 3, the thicknesses of the dielectric thin films 36 and 37 are each set to a value that maximizes transmittance of infrared rays IR when infrared rays IR are emitted from the rear onto the anti-reflection layer 35 at an incident angle of 60 degrees. Specifically, the thickness of one of two dielectric thin films 36 located closer to the base 32 is set to 100 nm, and the thickness of the other one of the dielectric thin films 36 located farther from the base 32 is set to 200 nm. Further, the thickness of one of two dielectric thin films 37 located closer to the base 32 is set to 30 nm, and the thickness of the other one of the dielectric thin films 37 located farther from the base 32 is set to 80 nm.

Characteristic line L1 indicates the following. When infrared rays IR are emitted onto measurement subject 1 at an incident angle of 0 degrees, the transmittance is maximal (several percent lower than 90%). When infrared rays IR are emitted onto measurement subject 1 at an incident angle greater than 0 degrees, the transmittance decreases as the incident angle increases. More specifically, when infrared rays IR are emitted onto measurement subject 1 at an incident angle greater than 0 degrees and less than 30 degrees, the transmittance gradually decreases as the incident angle increases. When infrared rays IR are emitted onto measurement subject 1 at an incident angle of 30 degrees or greater and less than 70 degrees, the transmittance decreases at a higher rate than when the incident angle of infrared rays IR is greater than 0 degrees and less than 30 degrees. When infrared rays IR are emitted onto measurement subject 1 at an incident angle of 70 degrees, the transmittance is less than 70%.

Characteristic line L2 indicates the following. Characteristic line L2 has similar tendencies as characteristic line L1. Specifically, when infrared rays IR are emitted onto measurement subject 2 at an incident angle of 0 degrees, the transmittance is maximal (close to 95%). When infrared rays IR are emitted onto measurement subject 2 at an incident angle greater than 0 degrees, the transmittance decreases as the incident angle increases. More specifically, when infrared rays IR are emitted onto measurement subject 2 at an incident angle greater than 0 degrees and less than 30 degrees, the transmittance gradually decreases as the incident angle increases. When infrared rays IR are emitted onto measurement subject 2 at an incident angle of 30 degrees, the transmittance is higher than 90%. When infrared rays IR are emitted onto measurement subject 2 at an incident angle greater than 30 degrees and less than 70 degrees, the transmittance decreases at a higher rate than when the incident angle of infrared rays IR is greater than 0 degrees and less than 30 degrees. When infrared rays IR are emitted onto measurement subject 2 at an incident angle of 70 degrees, the transmittance is close to 70%.

The anti-reflection layer 35 of measurement subject 2 restricts reflection of the infrared rays IR emitted onto measurement subject 2 at any incident angle in a range of 0 degrees to 70 degrees, inclusive. Accordingly, when infrared rays IR are emitted at any incident angle within the above angular range (0 degrees to 70 degrees, inclusive), a greater amount of infrared rays IR passes through the cover body of measurement subject 2 than measurement subject 1. Therefore, when infrared rays IR are emitted onto measurement subject 1 and measurement subject 2 at the same incident angle, the transmittance of the infrared rays IR through measurement subject 2 is higher than that of measurement subject 1.

Characteristic line L3 indicates the following. When infrared rays IR are emitted onto the anti-reflection layer 35 of measurement subject 3 at an incident angle of 0 degrees, the transmittance of the infrared rays IR is slightly higher than 90%. Further, when infrared rays IR are emitted onto measurement subject 3 at an incident angle greater than 0 degrees and less than 30 degrees, the transmittance is lower than that of measurement subject 2. However, when infrared rays IR are emitted onto the anti-reflection layer 35 of measurement subject 3 within the above angular range (0 degrees to 30 degrees, inclusive), the difference from the transmittance of measurement subject 2 gradually decreases as the incident angle increases. When the incident angle is 30 degrees, the difference becomes substantially zero.

When infrared rays IR are emitted onto measurement subject 3 at an incident angle within an angular range of 30 degrees to 60 degrees, inclusive, the transmittance is maximal. Characteristic line L3 shows such characteristics obtained by shifting characteristic line L2 to increase the incident angle at which the transmittance is maximal.

Also, when infrared rays IR are emitted at any incident angle within an angular range of 30 degrees to 60 degrees, inclusive, the transmittance of the infrared rays IR is as high as the maximal transmittance. At such an incident angle, the transmittance of infrared rays IR through the anti-reflection layer 35 of measurement subject 2 is higher than when infrared rays IR are emitted onto the anti-reflection layer 35 of measurement subject 3 at the same incident angle (characteristic line L2).

Further, characteristic line L3 indicates that when infrared rays IR are emitted onto the anti-reflection layer 35 at any incident angle within the angular range of 0 degrees to 60 degrees, inclusive, the transmittance of the infrared rays IR through the cover body 31 is 90% or higher.

### Advantages of the Present Embodiment

(1) As shown in FIG. 4, the anti-reflection layer 35 serves as at least one of two opposite surfaces of the cover body 31 in the emission direction.

This increases the transmittance (refer to characteristic lines L2 and L3 in FIG. 5) as compared to when the anti-reflection layer 35 is not included (refer to characteristic line L1 in FIG. 5). This advantage may be obtained when infrared rays IR are emitted at any incident angle within a range of 0 degrees to 70 degrees, inclusive.
(2) The anti-reflection layer 35 is configured so that the transmittance of infrared rays IR through the cover body 31 is maximal when infrared rays IR are emitted at an incident angle within an angular range of 30 degrees to 60 degrees, inclusive.

Accordingly, as shown by characteristic line L3 in FIG. 5, when infrared rays IR are emitted onto the anti-reflection layer 35 at any incident angle within the angular range of 0 degrees to 60 degrees, inclusive, the transmittance is relatively high.

Such an advantage may be obtained when infrared rays IR are emitted onto the cover body 31 while changing the emission direction within the angular ranges R1 and R2 with respect to the sideward direction and the vertical direction. Also, this advantage may be obtained when infrared rays IR are emitted onto the cover body 31 that is significantly tilted relative to both the vertical plane and the horizontal plane, as shown in FIG. 1.
(3) As shown in FIG. 4, the anti-reflection layer 35 has a uniform thickness. Therefore, the thickness of the anti-reflection layer 35 does not have to be gradually increased as the incident angle increases. Accordingly, the anti-reflection layer 35 may be readily formed as compared to the infrared sensor cover disclosed in Japanese Laid-Open Patent Publication No. 2023-173264.
(4) As shown in FIG. 4, the anti-reflection layer 35 is arranged at the rearmost part of the cover body 31 where the cover body 31 is irradiated with infrared rays IR emitted from the emitter 23 of the infrared sensor 21.

Therefore, as shown by characteristic line L3 in FIG. 5, when infrared rays IR are emitted from the rear onto the anti-reflection layer 35 located at the rearmost part of the cover body 31 an any incident angle within an angular range of 0 degrees to 60 degrees, inclusive, the transmittance is relatively high.
(5) As shown in FIG. 4, the anti-reflection layer 35 includes a dielectric multilayer film in which multiple dielectric thin films 36 and 37, each having a uniform thickness, are stacked. This dielectric multilayer film obtains a correlation between the incident angle at which the transmittance is maximal and the thicknesses of the dielectric thin films 36 and 37. The thicknesses of the dielectric thin films 36 and 37 are each set to a value that maximizes transmittance of infrared rays IR when infrared rays IR are emitted onto the anti-reflection layer 35 at an incident angle of within an angular range of 30 degrees to 60 degrees, inclusive.

The above-described thickness setting allows the transmittance to be relatively high when infrared rays IR are emitted onto the anti-reflection layer 35 at any incident angle within the above angular range (30 degrees to 60 degrees, inclusive).

The dielectric thin films 36 and 37 each have a uniform thickness. Therefore, the thicknesses of the dielectric thin films 36 and 37 do not have to be gradually increased as the incident angle increases. Accordingly, the dielectric thin films 36 and 37, in turn, the anti-reflection layer 35, may be readily formed as compared to a typical infrared sensor cover, such as the one disclosed in Japanese Laid-Open Patent Publication No. 2023-173264.
(6) The anti-reflection layer 35 is configured so that the transmittance of infrared rays IR through the cover body 31 is 90% or higher when infrared rays IR are emitted onto the anti-reflection layer 35 at an incident angle within an angular range of 0 degrees to 60 degrees, inclusive.

Therefore, when infrared rays IR are emitted from the emitter 23 of the infrared sensor 21 and enter the anti-reflection layer 35 at any incident angle within the above angular range (0 degrees to 60 degrees, inclusive), the infrared rays IR pass through the cover body 31 at a transmittance of 90% or higher. This improves detection accuracy of the infrared sensor 21.

### Modified Examples

The present embodiment may be modified as described below. The present embodiment and the following modifications can be combined as long as the combined modified examples remain technically consistent with each other.

### Base 32

Preferably, the color of the base 32 shown in FIG. 4 is black from viewpoints of design, noise reduction, and the like. The base 32 may be colored in a color other than black as long as the effect of the color on the performance of the infrared sensor 21 is permissible.

### Anti-Reflection Layer 35

In the above embodiment, the anti-reflection layer 35 is formed by a dielectric multilayer film in which the dielectric thin films 36 and 37 are stacked. The materials and the number of stacked layers of the dielectric thin films 36 and 37 may be changed.

The anti-reflection layer 35 shown in FIG. 4 may be arranged at a foremost part of the cover body 31, instead of or in addition to the rearmost part of the cover body 31. This modification may also be applied to the cover body 31 in the modified example shown in FIG. 11, which will be described later. When the anti-reflection layer 35 is arranged at the foremost part of the cover body 31, the front surface of the anti-reflection layer 35 serves as the front surface of the cover body 31, and also serves an ornamental surface of the infrared sensor cover 30.

In this modified example, the anti-reflection layer 35 at the front side is irradiated with infrared rays IR reflected by an object outside the vehicle 10 at the front. The anti-reflection layer 35 reduces reflection of infrared rays IR emitted from the front by having the infrared rays IR interfere each other, so that a decrease in the amount of the infrared rays IR that pass through the anti-reflection layer 35 due to the reflection is limited. This increases the amount of the infrared rays IR that pass through the anti-reflection layer 35 from the front toward the rear. As a result, the amount of the infrared rays IR that pass through the cover body 31 from the front to the rear is greater than that in a case in which the anti-reflection layer 35 is not arranged at the foremost part of the cover body 31.

In this modified example, in the same manner as the above embodiment, it is preferred that the anti-reflection layer 35 at the front side is configured so that the transmittance is maximal when infrared rays IR are emitted onto the front-side anti-reflection layer 35 at an incident angle within the angular range of 30 degrees to 60 degrees, inclusive.

This modified example obtains the same advantages as the above embodiment, although the direction in which infrared rays IR enter and pass through the anti-reflection layer 35 is opposite to that when the anti-reflection layer 35 is arranged at the rearmost part of the cover body 31. That is, the present modified example also readily restricts a decrease in the transmittance of infrared rays IR resulting from an increase in the incident angle.

In a case in which a request value of transmittance of infrared rays IR through the cover body 31 when infrared rays IR are emitted at an incident angle within an angular range of 0 degrees to 60 degrees, inclusive, is less than 90%, the anti-reflection layer 35 may be configured so that the transmittance is less than 90% as long as the transmittance value is greater than or equal to the request value.

### Cover Body 31

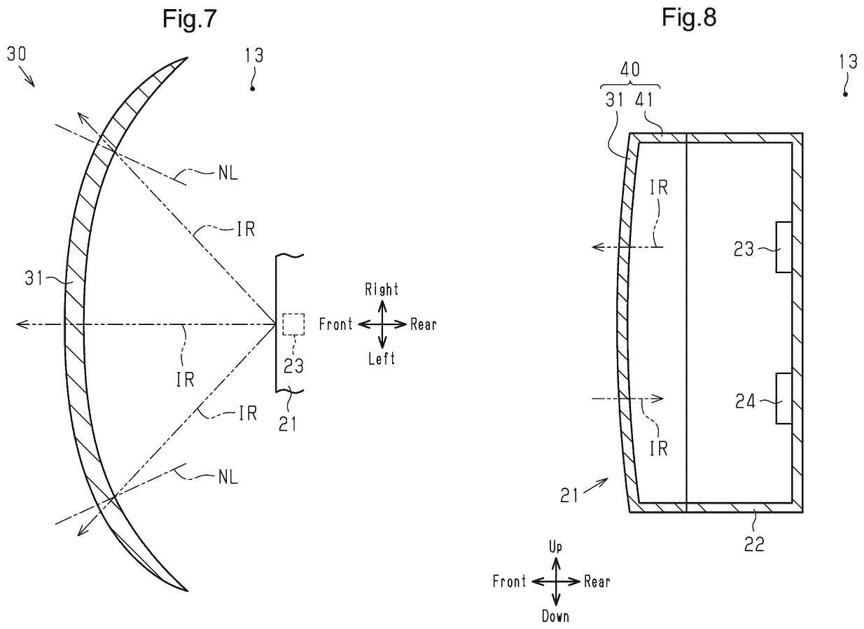

In the above embodiment, the cover body 31 has a shape of a flat plate. Instead, as shown in FIGS. 6 and 7, the cover body 31 may be curved to protrude forwardly. In this case, a central portion of the cover body 31 is located at the foremost position. A portion of the cover body 31 around the central portion (hereafter, referred to as the peripheral portion) is located rearward from the central portion. Further, the peripheral portion becomes closer to the rear as the peripheral portion extends away from the central portion. The base 32 is shaped in correspondence with the cover body 31.

The difference between the modified example shown in FIG. 6 and the modified example shown in FIG. 7 is that, in the former case, the thickness of the cover body 31 is uniform across the central portion and the peripheral portion, and in the latter case, the thickness of the peripheral portion is gradually decreased toward an edge. The thickness of the base 32 is set in the same manner as that of the cover body 31.

In FIGS. 6 and 7, the cover body 31 is illustrated as a single layer for the sake of convenience. However, the cover body 31 has the same layer structure as that of the above embodiment (refer to FIG. 4). The anti-reflection layer 35 has a uniform thickness. The anti-reflection layer 35 serves as at least one of two opposite surfaces of the cover body 31 in the emission direction.

When the cover body 31 is shaped as a flat plate having a uniform thickness, as described in the above embodiment, the amount of infrared rays IR reflected by the interface between the anti-reflection layer 35 and the air increases as the incident angle increases. Consequently, the amount of infrared rays IR that pass through the anti-reflection layer 35, in turn, the cover body 31 is decreased.

In this respect, in the modified examples shown in FIGS. 6 and 7, the cover body 31 is curved to protrude forwardly. Therefore, even if the incident angle increases, infrared rays IR may be emitted onto the cover body 31 in a direction relatively close to the normal line NL. This minimizes a level of reduction in the transmittance of infrared rays IR resulting from an increase in the incident angle.

Further, as shown in FIG. 7, when the thickness of the peripheral portion of the cover body 31 is gradually decreased toward the edge, the amount of infrared rays IR absorbed by the peripheral portion is reduced. This minimizes a decrease in the transmittance, and further improves detection accuracy of the infrared sensor 21.

### Others

The infrared sensor cover in accordance with the present disclosure may be arranged parallel to a vertical plane without tilting (i.e., orthogonal to a horizontal plane).

The cover 25 of the infrared sensor 21 shown in FIG. 2 may be replaced by an infrared sensor cover 40 shown in FIG. 8. In this case, the infrared sensor cover 40 includes a peripheral wall 41 disposed frontward from the case 22, and a plate-shaped cover body 31 located at a front end of the peripheral wall 41. The infrared sensor cover 40 is sized to close the front opening of the case 22 of the infrared sensor 21. The infrared sensor cover 40 covers the emitter 23 and the receiver 24 from the front.

In FIG. 8, the cover body 31 of the infrared sensor cover 40 is illustrated as a single layer for the sake of convenience. However, the cover body 31 has the same layer structure as the cover body 31 of the infrared sensor cover 30 described in the above embodiment (refer to FIG. 4).

Other than the infrared sensor cover 40, the present modified example has the same configuration as the above embodiment. Accordingly, in the modified example shown in FIG. 8, same reference characters are given to those components that are the same the above embodiment. Such components will not be described in detail.

Although the cover body 31 of the modified example shown in FIG. 8 is disposed at a position different from that of the above embodiment, the infrared sensor cover 40 covers the emitter 23 and the receiver 24 from the front, in the same manner as the above embodiment. Therefore, this modified example obtains the same operation and advantages as the above embodiment.

In FIG. 4, the protection layer 34 may be omitted from the cover body 31 when the anti-reflection layer 35 is tightly and directly fitted to the rear surface of the base 32. Further, the cover body 31 shown in FIG. 4 does not have to include the hard coat layer 33. Therese modifications may also be applied to the cover body 31 in the modified example shown in FIG. 11, which will be described later.

An additional layer may be included in the layer structure of the cover body 31 shown in FIG. 4.

The infrared sensor 21 and the infrared sensor cover 30, 40 (hereinafter, referred to as the infrared sensor 21 and the like) may be arranged at positions differing from those of the above embodiment, as long as the infrared sensor 21 and the like are located at an upper part (roof) of the vehicle 10. For example, the infrared sensor 21 and the like may be disposed at a rear part of the roof member 11 in the front-rear direction at a central portion or the like in the sideward direction.

The infrared sensor 21 and the like may be arranged at the upper part of the vehicle 10, such that the infrared sensor 21 and the like are partially located downward from the roof member 11.

The infrared sensor 21 and the like may be arranged at a position differing from that of the above embodiment, as long as the position is lower than the upper part (roof) of the vehicle 10.

In this case, the infrared sensor 21 and the like may be disposed at a front part of the vehicle 10 (e.g., front grille, front bumper, or the like). Alternatively, the infrared sensor 21 and the like may be disposed at a rear part of the vehicle 10 (e.g., rear bumper or the like).

When the infrared sensor 21 and the like are arranged at the rear part of the vehicle 10, the emitter 23 of the infrared sensor 21 emits infrared rays IR toward the rear of the vehicle 10. The infrared sensor cover 30, 40 is located frontward from the emitter 23 in the emission direction of infrared rays IR. In the present case, the infrared sensor cover 30, 40 is disposed at the rear of the vehicle 10 with respect to the emitter 23.

The infrared sensor 21 may be arranged inside the passenger compartment in the vicinity of a window glass (hereinafter, simply referred to as “glass”) 16, such as a front glass (windshield), a rear glass (back door glass), or the like. The front glass is tilted relative to both a vertical plane and a horizontal plane, such that the front glass becomes closer to the front as the front glass extends downwardly. The glass 16 allows passage of infrared rays IR. Thus, part of the glass 16 may be used as part of an infrared sensor cover.

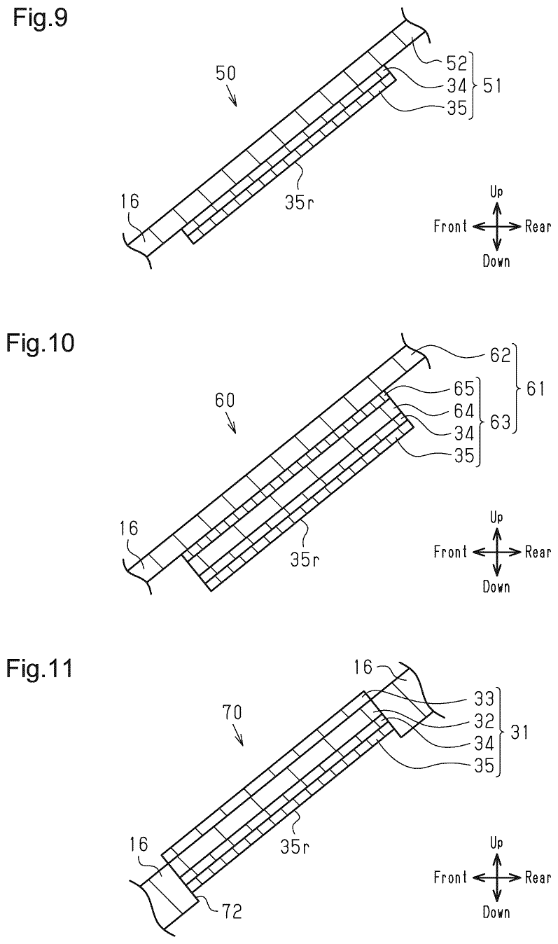

FIG. 9 and FIG. 10 show modified examples of the infrared sensor cover in which part of the glass 16 is used as part of the cover body.

In the modified example shown in FIG. 9, an infrared sensor cover 50 uses part of the glass 16 as the base 52. The anti-reflection layer 35 is formed on a rear side of the base 52. The protection layer 34 is located between the anti-reflection layer 35 and the base 52. In this case, the base 52, the protection layer 34, and the anti-reflection layer 35 form the cover body 51. The base 52 serves as the front end of the cover body 31. The cover body 51 allows passage of infrared rays IR. The double-dashed lines shown in FIG. 3 indicate the protection layer 34 and the anti-reflection layer 35 when the infrared sensor 21 is located rearward from an upper part of the front glass (glass 16).

In the modified example shown in FIG. 9, the protection layer 34 may be omitted from the cover body 51 when the anti-reflection layer 35 is tightly and directly fitted to the rear surface of the base 52.

In the modified example shown in FIG. 10, an infrared sensor cover 60 uses part of the glass 16 as a glass base 62. The infrared sensor cover 60 includes a film body 63 disposed on a rear side of the glass base 62. The anti-reflection layer 35 is arranged at a rearmost part of the film body 63. The film body 63 includes a film base 64, the anti-reflection layer 35, and an adhesion layer 65. The anti-reflection layer 35 is formed on a rear side of the film base 64. The protection layer 34 is located between the anti-reflection layer 35 and the film base 64. The adhesion layer 65 is formed on a front side of the film base 64. The film body 63 is adhered to the rear surface of the glass base 62 by the adhesion layer 65. The film base 64 and the adhesion layer 65 allow passage of infrared rays IR, in the same manner as the protection layer 34 and the anti-reflection layer 35.

The glass base 62 and the film body 63 form the cover body 61. The glass base 62 serves as the front end of the cover body 61. The film base 64 is located at an intermediate part of the cover body 61 in the front-rear direction. The cover body 61 allows passage of infrared rays IR.

In the modified example shown in FIG. 10, the protection layer 34 may be omitted from the cover body 61 when the anti-reflection layer 35 is tightly and directly fitted to the rear surface of the film base 64.

In the above embodiment, the base 32 is formed from a resin material. The modified example shown in FIG. 9 differs from the above embodiment in that the base 52 is formed by part of the glass 16. The modified example shown in FIG. 10 differs from the above embodiment in that the glass base 62 is formed by part of the glass 16. These modified examples satisfy the following conditions 1 to 3 in the same manner as the above embodiment.
Condition 1: The cover body 51, 61 includes the anti-reflection layer 35 having a uniform thickness.
Condition 2: The anti-reflection layer 35 serves as at least one of two opposite surfaces of the cover body 51, 61 in the emission direction, or more specifically, the rear surface of the cover body 51, 61.
Condition 3: The anti-reflection layer 35 is configured so that the transmittance of infrared rays IR through the cover body 51, 61 is maximal when infrared rays IR are emitted at an incident angle within an angular range of 30 degrees to 60 degrees, inclusive.

Thus, the infrared sensor cover 50, 60 obtains the same operation and advantages as the infrared sensor cover 30 of the above embodiment.

In another example in which part of the glass 16 is used as part of an infrared sensor cover, as shown in FIG. 11, part of the glass 16 may be cut out to form a through portion 72 that extends through the glass 16 in the front-rear direction. Then, the cover body 31, which includes the base 32, the hard coat layer 33, the protection layer 34, and the anti-reflection layer 35 in the same manner as the above embodiment, may be arranged in the through portion 72.

The through portion 72 may be formed in a position separated from an edge of the glass 16. In this case, the through portion 72 is surrounded by the glass 16. The cover body 31 and the surrounding glass 16 may form a main part or all of the infrared sensor cover 70.

Thus, the infrared sensor cover 70 obtains the same operation and advantages as the infrared sensor cover 30 of the above embodiment.

Sheet metal (not shown) may be disposed on the edge of the glass 16 and serve as part of the edge of the through portion 72. In this case, the through portion 72 is surrounded by the glass 16 and the sheet metal. The cover body 31, and the glass 16 and the sheet metal surrounding the cover body 31 form a main part or all of the infrared sensor cover 70.

In the infrared sensor cover 50, 60, 70, the glass 16 may be formed from an inorganic glass or an organic glass.

The infrared sensor 21 and the like may be mounted on a vehicle other than the land vehicle 10, such as a train, an aircraft, a vessel, or the like.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An infrared sensor cover, configured to be applied to an infrared sensor, the infrared sensor including an emitter configured to emit infrared rays toward outside of a vehicle, and a receiver configured to receive the infrared rays reflected by an object outside the vehicle, the infrared sensor cover being configured to cover the emitter and the receiver from a front with respect to an emission direction of the infrared rays, the infrared sensor cover comprising:
a cover body configured to allow passage of the infrared rays, wherein:
the cover body includes an anti-reflection layer configured to restrict reflection of the emitted infrared rays;
the anti-reflection layer serves as at least one of two opposite surfaces of the cover body in the emission direction, the anti-reflection layer having a uniform thickness; and
the anti-reflection layer is configured so that transmittance of the infrared rays through the cover body is maximal when the infrared rays are emitted onto the anti-reflection layer at an incident angle within an angular range of 30 degrees to 60 degrees, inclusive.

2. The infrared sensor cover according to claim 1, wherein the anti-reflection layer is arranged at a rearmost part of the cover body with respect to the emission direction.

3. The infrared sensor cover according to claim 1, wherein:
the anti-reflection layer includes a dielectric multilayer film in which multiple dielectric thin films, each having a uniform thickness, are stacked; and
the thickness of each of the dielectric thin films is set to a value that maximizes the transmittance of the infrared rays through the cover body when the infrared rays are emitted onto the anti-reflection layer at an incident angle within the angular range of 30 degrees to 60 degrees, inclusive.

4. The infrared sensor cover according to claim 1, wherein the anti-reflection layer is configured so that the transmittance of the infrared rays through the cover body is 90% or higher when the infrared rays are emitted onto the anti-reflection layer at an incident angle within an angular range of 0 degrees to 60 degrees, inclusive.
